(19) United States
(12) Patent Application Publication
(10) Pub. No.: US 2014/0065383 A1
(43) Pub. Date: Mar. 6, 2014

(54) Sticky Notes Made From Sugar Cane Paper, and Sticky Note Pads Including Same

(71) Applicants: Sarah Elizabeth TACKETT, Nashville, TN (US); Michael Neal Nilan, Smyrna, GA (US)

(72) Inventors: Sarah Elizabeth TACKETT, Nashville, TN (US); Michael Neal Nilan, Smyrna, GA (US)

(73) Assignees: TreeZero Paper, LLC, Atlanta, GA (US); IDG HOLDCO, LLC, Cookville, TN (US)

(21) Appl. No.: 14/011,929

(22) Filed: Aug. 28, 2013

Related U.S. Application Data
(60) Provisional application No. 61/693,927, filed on Aug. 28, 2012.

(51) Int. Cl. D21H 19/12; B42D 5/00

(52) U.S. Cl. CPC D21H 19/12; B42D 5/003
USPC 428/201; 162/135; 156/60

(57) ABSTRACT

Sticky notes made from sugar cane paper and sticky note pads including same. Sticky notes are formed from sugar cane paper made from sugar cane bagasse. Sugar cane bagasse is the fibrous by-product that remains after sugar cane stalks are crushed to extract sugar-bearing juice. The use of bagasse to form the sticky notes is an environmentally sustainable alternative to sticky notes made from tree-based products.

### CROSS-REFERENCE TO RELATED U.S. APPLICATION

This application is a non-provisional of, and claims the benefit under 35 U.S.C. §119(e) of the earlier filing date of U.S. Provisional Patent Application No. 61/693,927 filed on Aug. 28, 2012.

### FIELD OF THE INVENTION

This application discloses an invention which is related, generally and in various embodiments, to sticky notes made from sugar cane paper and sticky note pads including same.

### BACKGROUND OF THE INVENTION

Conventionally, a sticky note is a sheet of paper having a strip of repositionable adhesive on the underside. A sticky note pad is formed from a stack of sticky notes such that the top sticky note on each pad can be easily detached and secured to another surface. Such pads are manufactured, for example, by Minnesota Mining and Manufacturing Company under the “Post-It” trademark. These and other known sticky notes are formed from paper made from tree-based materials, and thus are not considered to be environmentally friendly.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of the underside of a sticky note made from sugar cane paper;

FIG. 2 illustrates the top side of the sticky note made from sugar cane paper of FIG. 1; and

FIG. 3 illustrates a perspective view a sticky note pad made from sugar cane paper.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

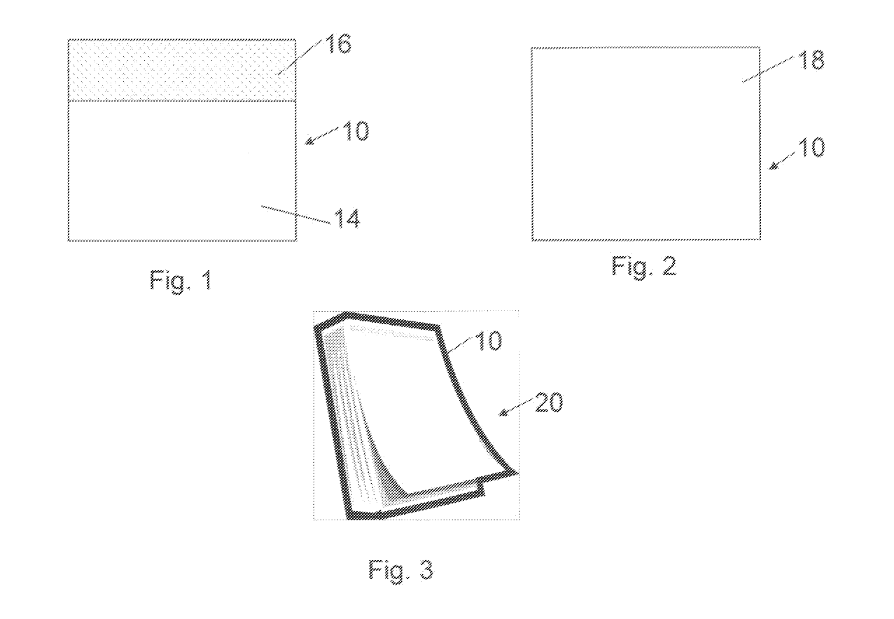

FIGS. 1 and 2 illustrate various embodiments of a sticky note 10 made from sugar cane paper. Like conventional sticky notes, sticky note 10 is formed from a paper sheet 12 having an underside including a non-adhesive portion 14 and an adhesive portion 16. The top side of sticky note 10 includes a non-adhesive portion 18. Adhesive portion 16 is disposed at one edge of the sticky note 10 and is formed by applying repositionable adhesive to at least a portion of sticky note 10. The repositionable adhesive may be any suitable repositionable adhesive. For example, according to various embodiments, the repositionable adhesive is a non-solvent, water based adhesive, such as, for example, a microsphere acrylic adhesive. The shape of sticky note 10 is not limited to a square or rectangle, but could be any suitable shape, including irregular shapes. Sticky note 10 may also be any color or include various patterns. FIG. 3 illustrates various embodiments of a sticky note pad 20 formed from a stack of sticky notes 10 of FIG. 1. Sticky note 10 is formed by applying the repositionable adhesive to at least a portion of the underside of the sticky note to form the adhesive portion 16 thereof. The application of the repositionable adhesive is not limited to a solid strip or layer of adhesive but may also include lines or spots of repositionable adhesive. To form the sticky note pad 20, adhesive portions 16 of the sticky notes 10 in the sticky note pad 20 are aligned with one another such that the adhesive portion 16 of a sticky note contacts the non-adhesive portion 18 of the topside of the sticky note 10 below it.

Sticky notes 10 according to various embodiments are formed from sugar cane paper made from 100% sugar cane bagasse. Sugar cane bagasse is the fibrous by-product that remains after sugar cane stalks are crushed to extract sugar-bearing juice. Paper sheets 12 are formed in a paper making process from pulp consisting of 100% sugar cane bagasse fibers. As such, the pulp used to make paper sheets 12 does not include any tree-based fibers. TreeZero, LLC of Atlanta, Ga., an assignee of the present application, is an exclusive distributor of paper made from 100% sugar cane bagasse. The use of bagasse to form the sticky notes 10 is an environmentally sustainable alternative to sticky notes made from tree-based products which can contribute to deforestation and the endangerment of wildlife. According to various embodiments, in lieu of paper sheets 12 being formed from 100% sugar cane bagasse fibers, paper sheets 12 are formed from greater than 80% sugar cane bagasse fibers. According to other embodiments, paper sheets 12 are formed from at least 90% sugar cane bagasse fibers. According to other embodiments, paper sheets 12 are formed from at least 95% sugar cane bagasse fibers.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A sticky note comprising:
a sheet of paper formed from pulp fibers comprising sugar cane bagasse; and
a repositionable adhesive in contact with at least a portion of the sheet of paper.

2. The sticky note of claim 1, wherein the sheet of paper is formed from pulp fibers comprising greater than 80% sugar cane bagasse.

3. The sticky note of claim 2, wherein the sheet of paper is formed from pulp fibers comprising at least 90% sugar cane bagasse.

4. The sticky note of claim 3, wherein the sheet of paper is formed from pulp fibers comprising 100% sugar cane bagasse.

5. The sticky note of claim 1, wherein the repositionable adhesive is a non-solvent, water based adhesive.

6. The sticky note of claim 5, wherein the non-solvent, water based adhesive is a microsphere acrylic adhesive.

7. A sticky note pad comprising:
a stack of sheet paper, wherein at least one paper comprises:
a sheet of paper formed from pulp fibers comprising sugar cane bagasse; and
a repositionable adhesive in contact with at least a portion of the sheet of paper.

8. The sticky note of claim 7, wherein the sheet of paper is formed from pulp fibers comprising greater than 80% sugar cane bagasse.

9. The sticky note of claim 8, wherein the sheet of paper is formed from pulp fibers comprising at least 90% sugar cane bagasse.

10. The sticky note of claim 9, wherein the sheet of paper is formed from pulp fibers comprising 100% sugar cane bagasse.

11. The sticky note pad of claim 7, wherein the repositionable adhesive is a non-solvent, water based adhesive.

12. The sticky note pad of claim 11, wherein the non-solvent, water based adhesive is a microsphere acrylic adhesive.

13. A method of making a sticky note comprising;
producing a sheet formed from pulp fibers comprising sugar cane bagasse;
applying a repositionable adhesive on at least a portion of the sheet of paper.

14. The method of making a sticky note of claim 13, wherein the sheet of paper is formed from pulp fibers comprising greater than 80% sugar cane bagasse.

15. The method of making a sticky note of claim 14, wherein the sheet of paper is formed from pulp fibers comprising at least 90% sugar cane bagasse.

16. The method of making a sticky note of claim 15, wherein the sheet of paper is formed from pulp fibers comprising 100% sugar cane bagasse.

17. The method of making a sticky note pad comprising:
producing a sheet formed from pulp fibers comprising sugar cane bagasse;
applying a repositionable adhesive on at least a portion of the sheet of paper;
connecting at least two sheets together.

18. The method of making a sticky note of claim 17, wherein the sheet of paper is formed from pulp fibers comprising greater than 80% sugar cane bagasse.

19. The method of making a sticky note of claim 18, wherein the sheet of paper is formed from pulp fibers comprising at least 90% sugar cane bagasse.

20. The method of making a sticky note of claim 19, wherein the sheet of paper is formed from pulp fibers comprising 100% sugar cane bagasse.
